(19) United States
(12) Patent Application Publication
(10) Pub. No.: US 2026/0285064 A1
(43) Pub. Date: Sep. 24, 2026

(54) TRANSPORTATION APPARATUS

(71) Applicant: KYOCERA DOCUMENT SOLUTIONS INC., OSAKA (JP)

(72) Inventor: MASAHIKO MIZUNO, OSAKA (JP)

(21) Appl. No.: 19/571,450

(22) Filed: Mar. 18, 2026

(30) Foreign Application Priority Data
Mar. 21, 2025 (JP) 2025-046739

(51) Int. Cl. B41J 11/00

(52) U.S. Cl. CPC B41J 11/007

(57) ABSTRACT

A transportation apparatus includes a plurality of suction blocks, plate portions, and a plurality of holes. Each of the plurality of suction blocks is configured to be capable of pulling a transportation target by suction through a transportation belt. The plurality of suction blocks is coupled to be arranged in a line in a transportation direction of the transportation target. The plate portions are respectively provided on suction blocks of the plurality of suction blocks. In a coupling portion in which the suction blocks adjacent to each other are coupled to each other, the plate portion includes a mountain-shaped ridge portion that protrudes in the transportation direction. Each plate portion supports the transportation belt slidably on a corresponding one of the plurality of suction blocks. The plurality of holes is provided to each plate portion. The hole has one side formed substantially parallel to the ridge portion.

### CROSS-REFERENCE TO RELATED PATENT APPLICATION

This application claims the benefit of Japanese Priority Patent Application JP 2025-046739 filed Mar. 21, 2025, the entire contents of which are incorporated herein by reference.

### FIELD OF THE DISCLOSURE

The present technology relates to a transportation apparatus that transports a transportation target in a transportation direction while pulling the transportation target by suction.

### BACKGROUND OF THE DISCLOSURE

For example, various apparatuses such as a printer multifunctional device are provided with transportation apparatuses used to transport a transportation target such as paper while pulling the transportation target by suction.

Japanese Patent Application Laid-open No. 2015-196575 discloses a transportation apparatus that is provided at a position at which the transportation apparatus faces an image forming section of an ink-jet recording type. In the transportation apparatus, paper transported on a transportation belt is pulled by suction toward the transportation belt by a suction apparatus such as a fan being driven, and the image forming section forms an image on the paper in this state.

### SUMMARY OF THE DISCLOSURE

A transportation apparatus according to the present technology includes a plurality of suction blocks, plate portions, and a plurality of holes. Each of the plurality of suction blocks is configured to be capable of pulling a transportation target by suction through a transportation belt. The plurality of suction blocks is coupled to be arranged in a line in a transportation direction of the transportation target. The plate portions are respectively provided on suction blocks of the plurality of suction blocks. In a coupling portion in which the suction blocks adjacent to each other are coupled to each other, the plate portion includes a mountain-shaped ridge portion that protrudes in the transportation direction. Each plate portion supports the transportation belt slidably on a corresponding one of the plurality of suction blocks. The plurality of holes is provided to each plate portion. The hole has one side formed substantially parallel to the ridge portion.

### BRIEF DESCRIPTION OF THE DRAWINGS

FIG. 1 is a perspective view of a transportation apparatus according to an embodiment of the present technology.

FIG. 2 is a perspective view of the transportation apparatus according to the embodiment of the present technology.

FIG. 3 is a top view of the transportation apparatus according to the embodiment of the present technology.

FIG. 4 is a cross-sectional view of the transportation apparatus in a Y-Z plane.

FIG. 5 is an enlarged view of a cross section of the transportation apparatus in the Y-Z plane.

FIG. 6 is a cross-sectional view of the transportation apparatus in an X-Z plane.

FIG. 7 is an enlarged view of a portion of the transportation apparatus, as viewed from above, and illustrates a shape of a ridge of a plate portion and a shape of a hole provided to the plate portion.

FIG. 8 is an enlarged view of a portion of the transportation apparatus, as viewed from above, and illustrates the shape of the ridge of the plate portion and the shape of the hole provided to the plate portion.

### DETAILED DESCRIPTION OF THE EXEMPLARY EMBODIMENTS

There is a need for a technology that makes it possible to transport a transportation target stably in a transportation direction while pulling the transportation target by suction efficiently. Thus, the present technology provides a technology that makes it possible to transport a transportation target stably in a transportation direction while pulling the transportation target by suction efficiently.

Hereinafter, embodiments of the present technology will be described with reference to the drawings.

### Overall Configuration and Configuration of Each Structural Element

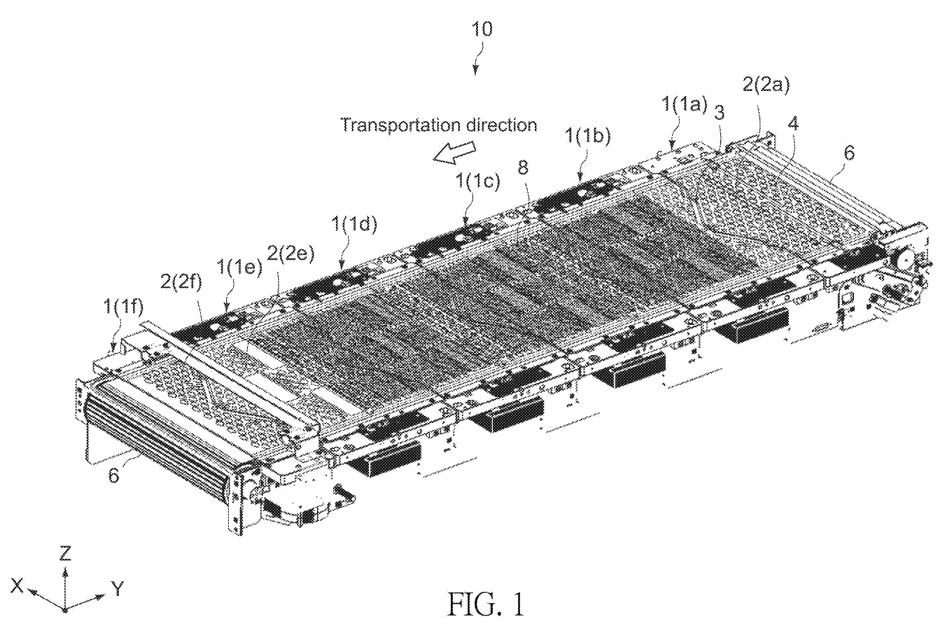

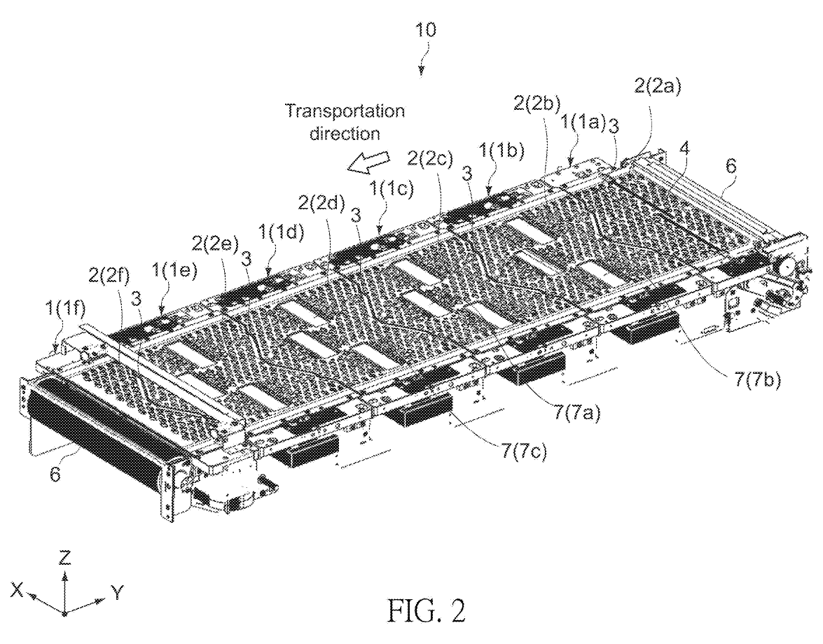

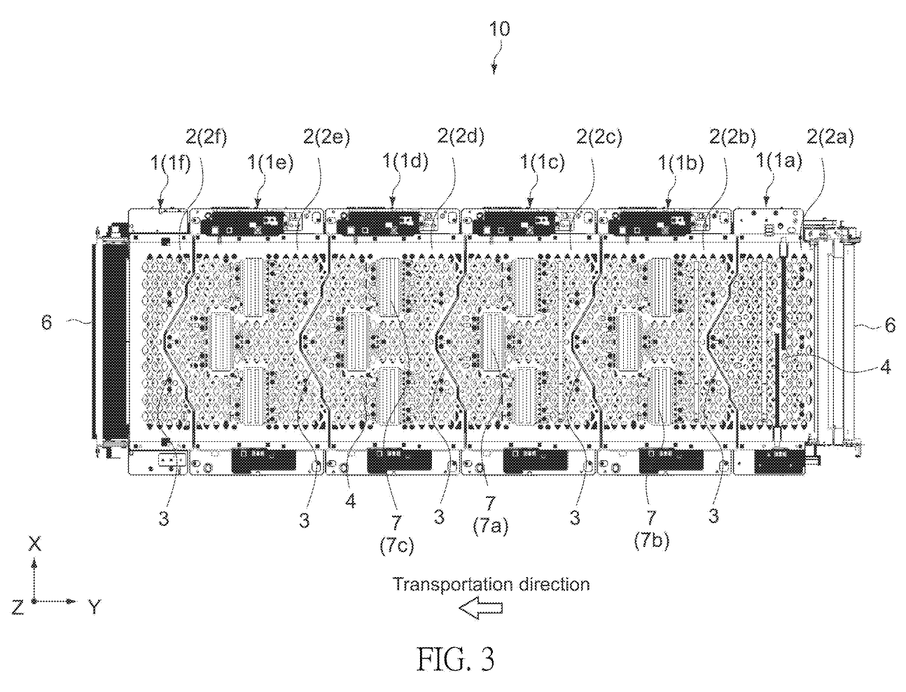

FIGS. 1 and 2 are perspective views of a transportation apparatus 10 according to an embodiment of the present technology. FIG. 3 is a top view of the transportation apparatus 10 according to the embodiment of the present technology. Note that FIG. 1 illustrates a partially broken transportation belt 8.

In each figure used for description in the present embodiment, a Z-axis direction represents an up-and-down direction of the transportation apparatus 10, an X-axis direction represents a width direction of the transportation apparatus 10, and a Y-axis direction represents a length direction of the transportation apparatus 10. Further, the Y-axis direction corresponds to a transportation direction of a transportation target.

The transportation apparatus 10 according to the present embodiment is used in, for example, a printer machine, a copying machine, a facsimile machine, or a multifunctional device (such as an image forming apparatus) that includes at least two of functions of the printer machine, the copying machine, and the facsimile machine (a printing function, a copying function, and a function to put into print). Note that the transportation apparatus 10 according to the present embodiment may be included in any apparatus when being used for the purpose of transporting a transportation target.

Typically, the transportation apparatus 10 is arranged at a position at which the transportation apparatus 10 faces a processor (such as an image formation processor that performs an image formation process). The transportation apparatus 10 is configured to accurately transport a transportation target when a corresponding process is performed.

Examples of the transportation target include paper, and the transportation target may be another object such as a substrate (typically, a sheet object that can be pulled by suction).

Referring to FIGS. 1 to 3, the transportation apparatus 10 according to the present embodiment includes six suction blocks 1 that are coupled to be arranged in a line in the transportation direction of a transportation target (the length direction of the transportation apparatus 10 or the Y-axis direction). In the example illustrated in the figures, the number of suction blocks 1 is six. However, any number of suction blocks that is at least two is acceptable. The six suction blocks 1 are each configured to be capable of pulling a transportation target by suction through the transportation belt 8.

A plate portion 2 (an upper plate) that supports the transportation belt 8 slidably is provided on each suction block 1.

Note that, in the description herein, each of the six suction blocks 1 is simply referred to as the suction block 1 when the six suction blocks 1 are not particularly to be distinguished. On the other hand, when the six suction blocks 1 are to be distinguished, the six suction blocks 1 are referred to as a first suction block 1a, a second suction block 1b, ..., and a sixth suction block 1f in this order from an upstream side in the transportation direction of a transportation target (the Y-axis direction).

Likewise, in the description herein, each of the six plate portions 2 is simply referred to as the plate portion 2 when the six plate portions 2 are not particularly to be distinguished. On the other hand, when the six plate portions 2 are to be distinguished, the six plate portions 2 are referred to as a first plate portion 2a, a second plate portions 2b, ..., and a sixth plate portion 2f in this order from the upstream side in the transportation direction of the transportation target (the Y-axis direction).

Note that the first plate portion 2a to the sixth plate portion 2f are respective plate portions of the first suction block 1a to the sixth suction block 1f.

In the present embodiment, the plate portion 2 is a metallic plate made of various kinds of metal. However, the plate portion 2 may be made of another material such as resin. In a coupling portion (a boundary portion of the plate portions 2 adjacent to each other) in which the suction blocks 1 adjacent to each other are coupled to each other, the plate portion 2 includes a mountain-shaped ridge portion 3 that protrudes downstream in the transportation direction of a transportation target (the Y-axis direction).

Specifically, with respect to the first plate portion 2a arranged most upstream in the transportation direction (the Y-axis direction), an upstream edge portion of the first plate portion 2a in the transportation direction has a linear shape in the width direction (the X-axis direction), whereas a downstream edge portion of the first plate portion 2a in the transportation direction is the mountain-shaped ridge portion 3 protruding downstream in the transportation direction.

Further, with respect to the second to fifth plate portions 2b to 2e respectively arranged second most upstream to fifth most upstream in the transportation direction (the Y-axis direction), both an upstream edge portion and a downstream edge portion of each of the second to fifth plate portions 2b to 2e in the transportation direction are the mountain-shaped ridge portions 3 protruding downstream in the transportation direction.

Furthermore, with respect to the sixth plate portion 2f arranged most downstream in the transportation direction (the Y-axis direction), a downstream edge portion of the sixth plate portion 2f in the transportation direction has a linear shape in the width direction (the X-axis direction), whereas an upstream edge portion of the sixth plate portion 2f in the transportation direction is the mountain-shaped ridge portion 3 protruding downstream in the transportation direction.

The plate portion 2 includes a plurality of holes 4 used for suction. In the present embodiment, a shape of the hole 4 is related to a shape of the ridge. The shape of the ridge and the shape of the hole 4 will be described in detail later.

The transportation belt 8 is long in the transportation direction and attached to the transportation apparatus 10 to surround the transportation apparatus 10. The transportation belt 8 rotates about an X axis by being driven by a roller, and this results in transporting a transportation target that is placed on the transportation belt 8 and pulled by suction. The transportation belt 8 includes a hole smaller than the hole 4 provided to the plate portion 2.

Two main rollers 6 that can rotate about the X axis are respectively provided to two ends of the transportation apparatus 10 in the longitudinal direction (the Y-axis direction). One of the two main rollers 6 is a drive roller driven by a driving source such as a motor, whereas another of the two main rollers 6 is a follower roller driven in response to the driving of the drive roller. Note that both of the two main rollers 6 may be drive rollers.

Four of the six suction blocks 1 (the second to fifth suction blocks 1b to 1e) that are not the first suction block 1a being situated most upstream or the sixth suction block 1f being situated most downstream are each provided with three sub rollers 7 each exposed through the plate portion 2 toward the transportation belt 8.

Note that, in the description herein, each of the three sub rollers 7 is simply referred to as the sub roller 7 when the three sub rollers 7 are not particularly to be distinguished. On the other hand, when the three sub rollers 7 are to be distinguished, the three sub rollers 7 are referred to as a first sub roller 7a, a second sub roller 7b, and a third sub roller 7c.

Typically, the sub roller 7 is a follower roller, and can smoothly rotate the transportation belt 8 pulled toward the plate portion 2 due to sucking force. The sub roller 7 is provided to be rotatable about the X axis. A highest portion of the sub roller 7 in the up-and-down direction (the Z-axis direction) is set to be at the same position as an upper surface of the plate portion 2 or to be at a slightly higher position than the upper surface of the plate portion 2.

Around a middle portion of the transportation apparatus 10 in the width direction (the X-axis direction), the first sub roller 7a from among the three sub rollers 7 is arranged downstream of the second sub roller 7b and the third sub roller 7c in the transportation direction (the Y-axis direction).

On the other hand, in one of end portions of the transportation apparatus 10 in the width direction (the X-axis direction), the second sub roller 7b is arranged upstream of the first sub roller 7a in the transportation direction (the Y-axis direction). Further, in another of the end portions of the transportation apparatus 10 in the width direction (the X-axis direction), the third sub roller 7c is arranged upstream of the first sub roller 7a in the transportation direction (the Y-axis direction) at the same position as the second sub roller 7b in the transportation direction.

Note that, in the present embodiment, the three sub rollers 7 are typically arranged to form a shape of a mountain since the ridge portion 3 of the plate portion 2 has a shape of a mountain.

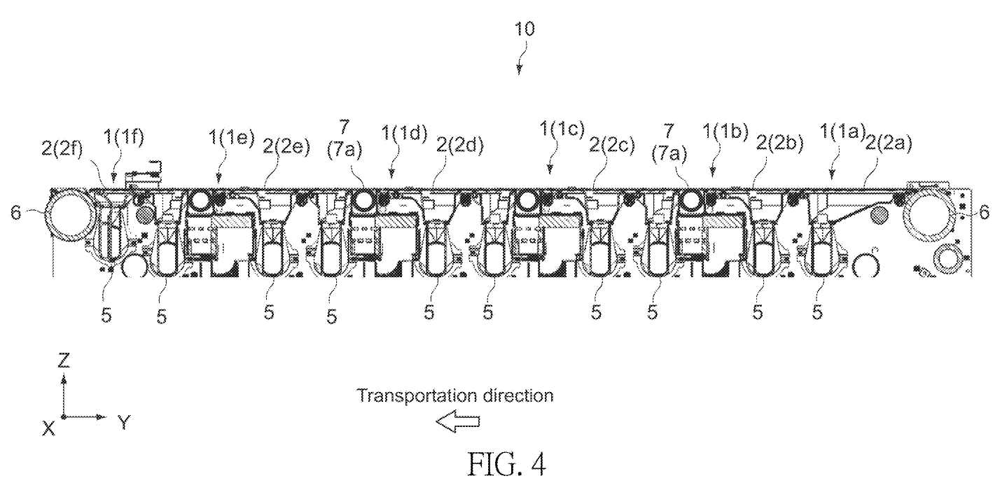

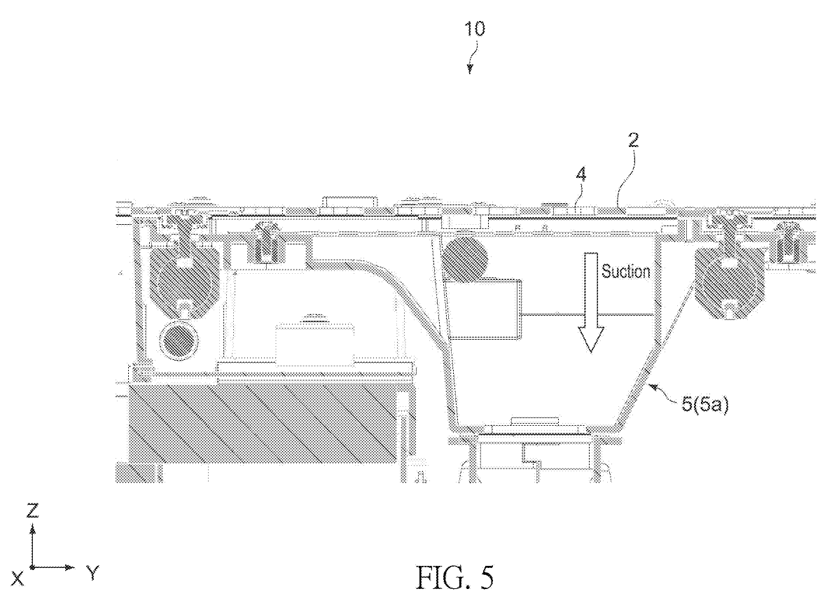

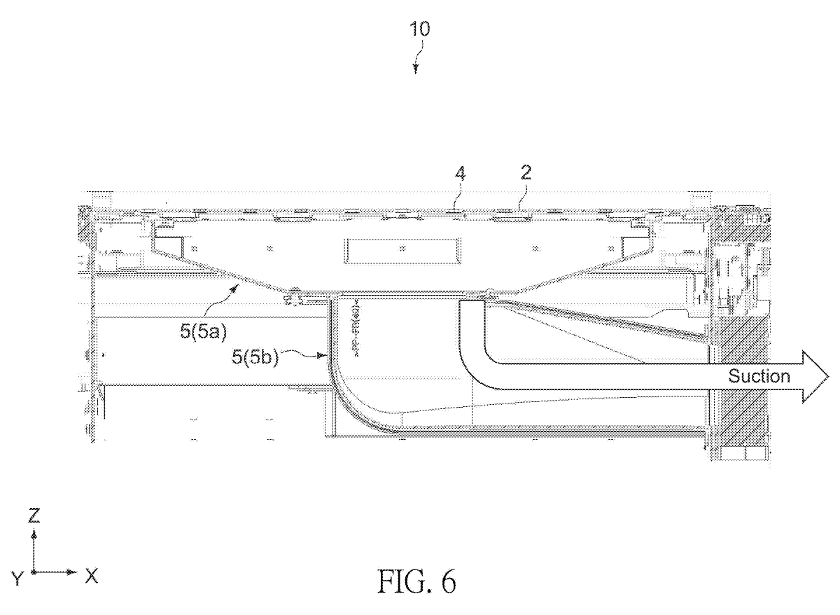

FIG. 4 is a cross-sectional view of the transportation apparatus 10 in a Y-Z plane. FIG. 5 is an enlarged view of a cross section of the transportation apparatus 10 in the Y-Z plane. FIG. 6 is a cross-sectional view of the transportation apparatus 10 in an X-Z plane.

As illustrated in FIGS. 4 to 6, a duct portion 5 used for suction is provided in each of the six suction blocks 1. From among the six suction blocks 1, the first suction block 1a being situated most upstream in the transportation direction (the Y-axis direction) and the sixth suction block 1f being situated most downstream in the transportation direction each include one duct portion 5.

On the other hand, from among the six suction blocks 1, the second to fifth suction blocks 1b to 1e respectively situated second most upstream to fifth most upstream in the transportation direction (the Y-axis direction) are each provided with two duct portions 5.

The duct portion 5 includes an upper duct 5a situated on an upside of the duct portion 5, and a lower duct 5b situated on a downside of the duct portion 5. The upper duct 5a has an inverted truncated square pyramidal shape having a wider upper portion that corresponds to an airflow-inlet side, and a narrower lower portion that corresponds to an airflow-outlet side. The lower duct 5b has a bent cylindrical shape having a wider upper potion that corresponds to an airflow-inlet side, and a narrower lower portion that corresponds to an airflow-outlet side. The lower duct 5b enables airflow sucked in through the upper portion to be discharged externally in the width direction (the X-axis direction).

Note that a suction section (not illustrated) is provided on the airflow-outlet side of the lower duct 5b (outside of the lower duct 5b in the width direction or the X-axis direction), that is, on a side of one of the end portions of the transportation apparatus 10 in the width direction. Examples of the suction section include a fan and a vacuum pump. However, any apparatus that can generate a sucking force may be used.

In the present embodiment, a single suction section is shared to be used by all of the suction blocks 1 (that is, by all of the duct portions 5). On the other hand, a single suction section may be shared to be used by at least two of all of the suction blocks 1 (or by at least two of the duct portions 5).

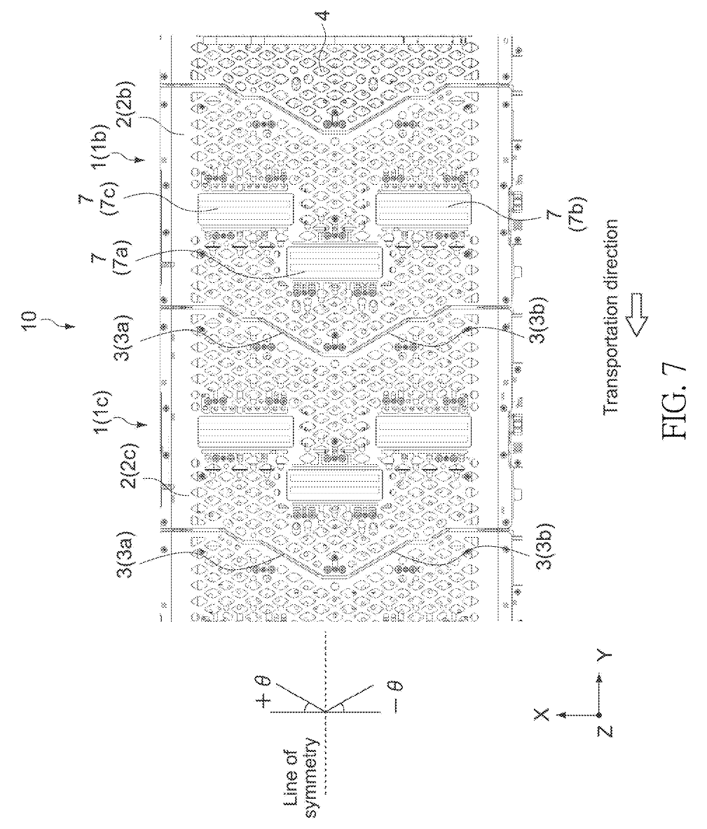

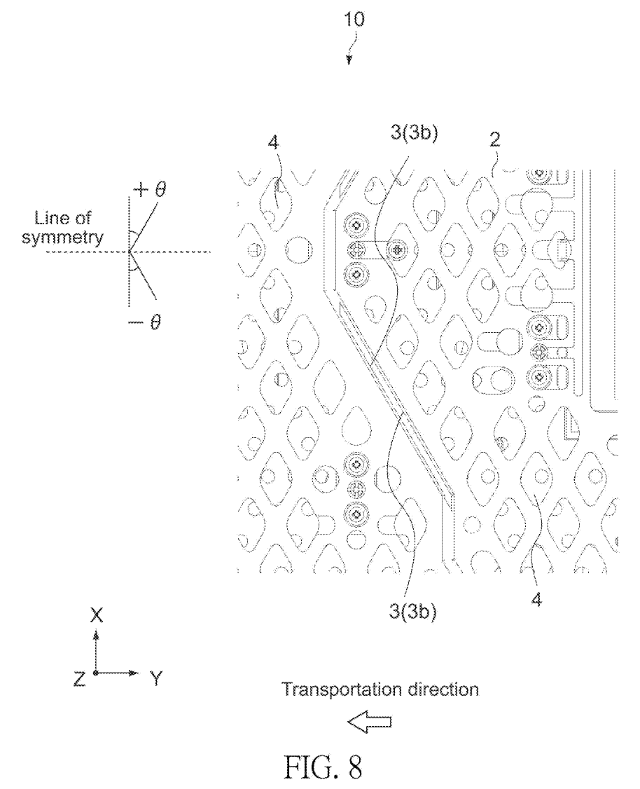

FIGS. 7 and 8 are enlarged views of portions of the transportation apparatus 10, as viewed from above, and each illustrate a shape of a ridge of the plate portion 2 and a shape of the hole 4 provided to the plate portion 2.

Here, in the present embodiment, the transportation belt 8 is pulled toward the upper surface of the plate portion 2 due to sucking force. Thus, a normal force between a lower surface of the transportation belt 8 and the upper surface of the plate portion 2 is great, and friction between the lower surface of the transportation belt 8 and the upper surface of the plate portion 2 is great. Therefore, in the present embodiment, the ridge portion 3 situated at a boundary of the plate portions 2 has a mountain shape that protrudes in the transportation direction. This results in reducing the friction.

On the other hand, it is necessary that the hole 4 used for suction be provided to the plate portion 2. When the hole 4 has a shape, such as a simple circular shape, that is not related to the ridge, it is difficult to arrange the hole 4 in the plate portion 2 properly. For example, a portion such as an edge portion of the plate portion 2 that includes the ridge portion 3 has a large empty region that is not the hole 4. As a result, a transportation target is not pulled by suction with a proper sucking force, and thus is not transported stably and accurately. This may result in unstably performing processing (such as an image forming process) on the transportation target (such as paper).

Thus, in the present embodiment, the shape of the ridge portion 3 in the plate portion 2 and the shape of the hole 4 in the plate portion 2 are related to each other. The shapes of the ridge portion 3 and the hole 4 in the plate portion 2 are described in detail below with reference to FIGS. 7 and 8.

The ridge portion 3 has a mountain shape that protrudes downstream in the transportation direction. The ridge portion 3 has a symmetrical shape about a line of symmetry that is a line passing the middle in the width direction (the X-axis direction) and being parallel to the transportation direction (the Y-axis direction). In the description of the present embodiment, a portion of the ridge portion 3 that is obtained by dividing the ridge portion 3 with the line of symmetry is referred to as a first ridge portion 3a, and another portion of the ridge portion 3 that is obtained by the division is referred to as a second ridge portion 3b. In other words, the ridge portion 3 includes the first ridge portion 3a and the second ridge portion 3b.

The first ridge portion 3a is formed to be inclined a first angle +θ with respect to the width direction (the X-axis direction) of the transportation apparatus 10 about an axis extending in the up-and-down direction (the Z-axis direction). On the other hand, the second ridge portion 3b is formed to be inclined a second angle -θ with respect to the width direction (the X-axis direction) of the transportation apparatus 10 about the axis extending in the up-and-down direction (the Z-axis direction). Note that, with respect to the symbols "+/-" in the angles, the symbol "+" represents clockwise rotation and the symbol "-" represents counterclockwise rotation (rotational directions, as viewed from above).

In this example, the first angle +θ and the second angle -θ have the same absolute value θ. However, the first angle +θ and the second angle -θ may be set to have different absolute values θ (in this case, the first ridge portion 3a and the second ridge portion 3b are asymmetric).

Note that, in the present embodiment, all of portions of the ridge portion 3 are not inclination portions that are inclined with respect to the width direction (the X-axis direction). Three portions that are a top portion, a side portion, a foot portion of the mountain shape are non-inclination portions that are not inclined with respect to the width direction. On the other hand, all of the portions of the ridge portion 3 except for the foot portion of the mountain shape may be inclination portions, or all of the portions of the ridge portion 3 may be inclination portions.

Each of the plurality of holes 4 formed in the plate portion 2 has a shape of a parallelogram that has two sides each forming a certain angle with respect to the width direction, and two sides each forming another angle with respect to the width direction, where the certain angle is substantially equal to the first angle +θ formed by the first ridge portion 3a, and the other angle is substantially equal to the second angle -θ formed by the second ridge portion 3b. Here, "substantially equal" means that having a difference such as a manufacturing error is considered equal. For example, having a difference such as about +/-5 degrees may be considered substantially equal.

In the present embodiment, the parallelogram-shaped holes 4 are regularly arranged in the plate portion 2. Specifically, the parallelogram-shaped holes 4 are arranged in a line in the transportation direction (the Y-axis direction), and pluralities of the parallelogram-shaped holes 4 arranged in a line are arranged in the width direction (the X-axis direction) to form multiple lines.

Note that a position of the center of a parallelogram included in one of two lines adjacent to each other in the width direction (the X-axis direction) is set to correspond to a position midway between two adjacent parallelograms that are included in another of the two lines.

In the present embodiment, all of the parallelograms have the same area. However, at least a portion of the parallelograms may have different areas.

Here, typically, the hole 4 may have any shape formed to have at least one side substantially parallel (for example, having a difference such as about +/-5 degrees) to the ridge portion 3 (+θ, -θ). Note that, in the present embodiment, all of the holes 4 are not parallelogram-shaped, but the hole 4 having another shape (such as a circular or triangular shape) is arranged as necessary in a portion that is still empty after the parallelogram-shaped holes 4 are arranged regularly.

### Effects and Others

In the present embodiment, the ridge portion 3 situated at a boundary of the plate portions 2 has a mountain shape that protrudes in the transportation direction. This makes it possible to reduce the friction between the transportation belt 8 and the plate portion 2.

Further, in the present embodiment, the shape of the hole 4 of the plate portion 2 is a shape related to the ridge portion 3, and is typically a shape having at least one side substantially parallel to the ridge portion 3. This makes it possible to regularly arrange the holes 4 in the plate portion 2, and thus to reduce an empty region that is not the hole 4.

This makes it possible to transport a transportation target stably and accurately while pulling the transportation target by suction efficiently with a proper sucking force. This results in being able to stably perform processing (such as an image forming process) on the transportation target (such as paper).

Here, the plate portion 2 (transportation plate metal) provides a relatively low degree of freedom in layout for the shape of the hole 4. However, the above-described regular arrangement of the holes 4 makes it possible to manufacture the plate portion 2 at relatively low costs with no limitations on the layout.

Further, particularly in the present embodiment, the hole 4 has a shape of a parallelogram that has two sides each substantially parallel to the first ridge portion 3a, and two sides each substantially parallel to the second ridge portion 3b.

This makes it possible to regularly arrange the parallelogram-shaped holes 4 in the plate portion 2, and thus to further reduce an empty region that is not the hole 4. This makes it possible to transport a transportation target stably and accurately while pulling the transportation target by suction efficiently with a more proper sucking force. Further, the regular arrangement of the parallelogram-shaped holes 4 makes it possible to manufacture the plate portion 2 at much lower costs with no limitations on the layout.

Furthermore, in the present embodiment, the three sub rollers 7 are typically arranged to form a shape of a mountain since the ridge portion 3 situated at a boundary of the plate portions 2 has a mountain shape. Such an arrangement of the three sub rollers 7 makes it possible to further reduce the friction between the transportation belt 8 and the plate portion 2.

Moreover, in the present embodiment, a single suction section is shared to be used by at least two suction blocks 1. This makes it possible to reduce the number of suction sections, and thus to reduce costs.

It should be understood by those skilled in the art that various modifications, combinations, sub-combinations and alterations may occur depending on design requirements and other factors insofar as they are within the scope of the appended claims or the equivalents thereof.

What is claimed is:

1. A transportation apparatus, comprising:
a plurality of suction blocks each configured to be capable of pulling a transportation target by suction through a transportation belt, the plurality of suction blocks being coupled to be arranged in a line in a transportation direction of the transportation target;
plate portions that are respectively provided on suction blocks of the plurality of suction blocks, the plate portion including a mountain-shaped ridge portion in a coupling portion in which the suction blocks adjacent to each other are coupled to each other, the ridge portion protruding in the transportation direction, each plate portion supporting the transportation belt slidably on a corresponding one of the plurality of suction blocks; and
a plurality of holes provided to each plate portion, each of the plurality of holes has one side formed substantially parallel to the ridge portion.

2. The transportation apparatus according to claim 1, wherein
the ridge portion includes
a first ridge portion that is inclined a first angle with respect to a width direction of the transportation apparatus that is orthogonal to the transportation direction, and
a second ridge portion that is inclined a second angle with respect to the width direction.

3. The transportation apparatus according to claim 2, wherein
each of the plurality of holes has a shape of a parallelogram that has two sides each substantially parallel to the first ridge portion, and two sides each substantially parallel to the second ridge portion.

4. The transportation apparatus according to claim 1, further comprising
a plurality of rollers each exposed through the plate portion toward the transportation belt.

5. The transportation apparatus according to claim 4, wherein
the plurality of rollers includes
a first roller that is arranged in a middle portion of the transportation apparatus in a width direction of the transportation apparatus that is orthogonal to the transportation direction,
a second roller that is arranged upstream of the first roller in the transportation direction in one of end portions of the transportation apparatus in the width direction, and
a third roller that is arranged upstream of the first roller in the transportation direction at the same position as the second roller in the transportation direction in another of the end portions in the width direction.

6. The transportation apparatus according to claim 1, further comprising
a suction section that generates a sucking force used to pull the transportation target by suction, the suction section being shared to be used by at least two of the plurality of suction blocks.
